(19) United States
(12) Patent Application Publication
(10) Pub. No.: US 2026/0093898 A1
(43) Pub. Date: Apr. 2, 2026

(54) GENERATING CORRECTED SENTENCE-CASE TEXT

(71) Applicant: Walmart Apollo, LLC, Bentonville, AR (US)

(72) Inventors: Silu Wang, Santa Clara, CA (US); Tong Yao, San Jose, CA (US); Zigeng Wang, Santa Clara, CA (US); Wei Shen, Pleasanton, CA (US)

(73) Assignee: Walmart Apollo, LLC, Bentonville, AR (US)

(21) Appl. No.: 18/901,596

(22) Filed: Sep. 30, 2024

(51) Int. Cl. G06F 40/166; G06F 40/232; G06F 40/295

(52) U.S. Cl. CPC G06F 40/166; G06F 40/232; G06F 40/295

(57) ABSTRACT

Examples relate to a system including a processor that can perform certain operations. The operations can include obtaining input text. The operations also can include generating a set of vectors from an ensemble of machine-learning models based on the input text. The ensemble of machine-learning models can include a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names. The QA-NER model can include a transformer language model and a linear layer. The operations additionally can include generating corrected sentence-case text by modifying capitalization of the input text based on the set of vectors and outputting the corrected sentence-case text on a draft advertisement user interface. Other embodiments are described.

### TECHNICAL FIELD

This disclosure relates generally to generating corrected sentence-case text.

### BACKGROUND

Modern online retail platforms and advertising systems often deal with large amounts of content. There can be many types of content, such as product descriptions, marketing materials, etc., which can originate from diverse sources. For example, such content can be user-generated and/or automatically generated. The nature of this content creation often results in variations in formatting, capitalization, etc.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for generating corrected sentence-case text, according to an embodiment;

FIG. 4 illustrates flow chart for a training pipeline for training a QA-NER model using training data to generate a fine-tuned QA-NER model, according to an embodiment;

FIG. 5 illustrates flow chart for an inference pipeline for using a QA-NER model, according to an embodiment;

FIG. 6 illustrates flow chart for an ensemble pipeline for using an ensemble of models to generate corrected sentence-case text, according to an embodiment;

FIG. 7 illustrates an example of a user interface, showing a piece of content for ad copy, with identification of corrections to be made; and

FIG. 8 illustrates a flow chart for a method of generating corrected sentence-case text, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.05 second, 0.1 second, 0.02 second, 0.5 second, one second, or two seconds.

### DETAILED DESCRIPTION

Various embodiments include a system including a processor and a non-transitory computer-readable medium storing computing instructions that, when executed on the processor, cause the processor to perform certain operations. The operations can include obtaining input text. The operations also can include generating a set of vectors from an ensemble of machine-learning models based on the input text. The ensemble of machine-learning models can include a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names. The QA-NER model can include a transformer language model and a linear layer. The linear layer can be configured to reduce a vector output from the transformer language model to a two-dimensional vector including a start position and an end position of a brand in the input text. The operations additionally can include generating corrected sentence-case text by modifying capitalization of the input text based on the set of vectors.

A number of embodiments include a computer-implemented method. The method can include obtaining input text. The method also can include preprocessing the input text to remove special characters and extra spaces. The method additionally can include generating a set of vectors from an ensemble of machine-learning models based on the input text. The ensemble of machine-learning models can include a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names. The QA-NER model can include a transformer language model and a linear layer. The linear layer can be configured to reduce a vector output from the transformer language model to a two-dimensional vector including a start position and an end position of a brand in the input text. The method additionally can include generating corrected sentence-case text by modifying capitalization of the input text based on the set of vectors.

Additional embodiments include a non-transitory computer-readable medium storing computing instructions that, when executed on a processor, cause the processor to perform certain operations. The operations can include obtaining input text. The operations also can include generating a set of vectors from an ensemble of machine-learning models based on the input text. The ensemble of machine-learning models can include a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names. The QA-NER model can include a transformer language model and a linear layer. The linear layer can be configured to reduce a vector output from the transformer language model to a two-dimensional vector including a start position and an end position of a brand in the input text. The operations additionally can include generating corrected sentence-case text by modifying capitalization of the input text based on the set of vectors. The operations further can include causing the corrected sentence-case text to be outputted on a draft advertisement user interface.

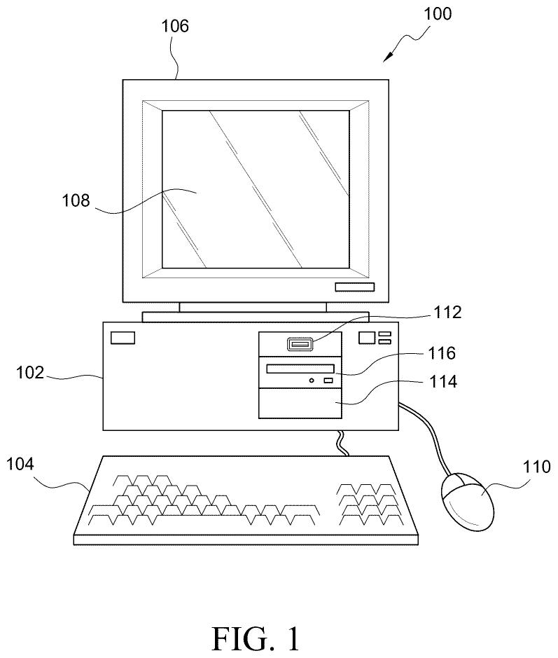

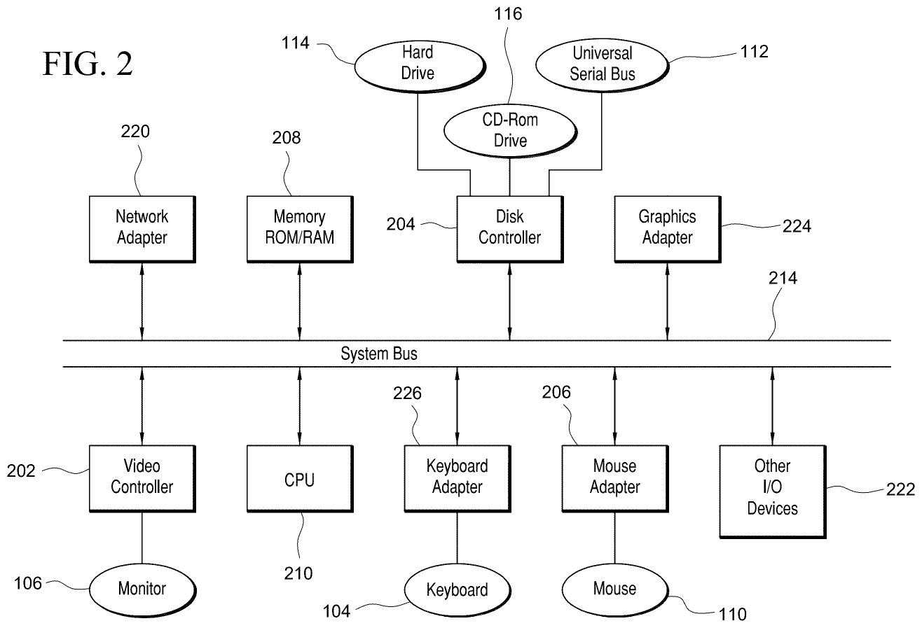

Turning to the drawings, FIG. 1 illustrates an embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Example operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further examples of operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

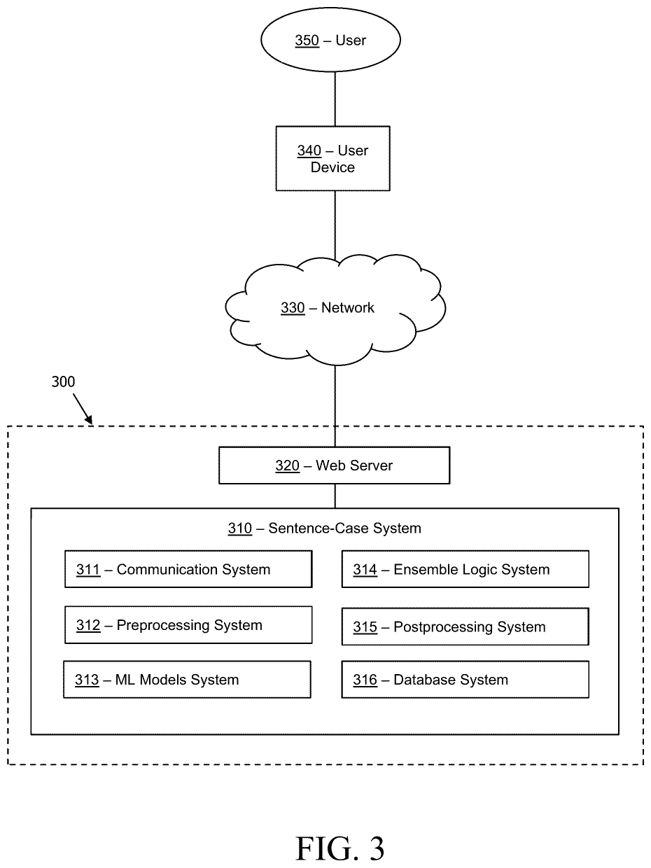

Turning ahead in the drawings, FIG. 3 illustrates a block diagram of a system 300 that can be employed for generating corrected sentence-case text, according to an embodiment. System 300 is merely an example, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a sentence-case system 310 and/or a web server 320. Generally, system 300 can be implemented with hardware and/or software, as described herein.

Sentence-case system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host sentence-case system 310 and/or web server 320.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can be a web server that hosts a website, or provides a server that interfaces with an application (e.g., a mobile application), for user device 340, which can allow users (e.g., 350) to submit content, moderate content, detect sentence-case violations, generate sentence-case corrected text, review suggested corrections, and/or or other suitable activities, or to interface with and/or configure sentence-case system 310.

In some embodiments, an internal network that is not open to the public can be used for communications between sentence-case system 310 and web server 320 within system 300. Accordingly, in some embodiments, sentence-case system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand.

Examples of mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement the iPhone® operating system by Apple Inc. of Cupertino, California, United States of America, the Android™ operating system developed by the Open Handset Alliance, or another suitable operating system.

In many embodiments, sentence-case system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to sentence-case system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of sentence-case system 310 and/or web server 320. In a similar manner, the processors and/or the non-transitory computer-readable media can be local and/or remote to each other.

Meanwhile, in many embodiments, sentence-case system 310 and/or web server 320 also can be configured to communicate with one or more databases, such as a database system 316. The one or more databases can include an item database that contains information about items, products, or SKUs (stock keeping units), search queries, attribute-value information, for example, among other information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Examples of database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, sentence-case system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Examples of PAN protocol(s) can include Bluetooth, Zigbee, Wireless Universal Serial Bus (USB), Z-Wave, etc. ; examples of LAN and/or WAN protocol(s) can include Institute of Electrical and Electronic Engineers (IEEE) 802.3 (also known as Ethernet), IEEE 802.11 (also known as WiFi), etc.; and examples of wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, examples of communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further examples of communication hardware can include wireless communication hardware including, for example, one or more radio transceivers, one or more infrared transceivers, etc. Additional examples of communication hardware can include one or more networking components (e.g., modulator-demodulator components, gateway components, etc.).

In many embodiments, sentence-case system 310 can include a communication system 311, a preprocessing system 312, a machine learning (ML) models system 313, an ensemble logic system 314, a postprocessing system 315, and/or database system 316. In many embodiments, the systems of sentence-case system 310 can be modules of computing instructions (e.g., software modules) stored at non-transitory computer readable media that operate on one or more processors. In other embodiments, the systems of sentence-case system 310 and/or web server 320 can be implemented in hardware. Additional details regarding the systems of sentence-case system 310 are described below.

Modern advertising and e-commerce strategies generally involve creating messaging. Proper formatting and presentation of ad copy, product descriptions, and other marketing text can advantageously help with effectively engaging customers and maintaining brand consistency. One aspect of text formatting is the appropriate use of capitalization, particularly sentence case. Sentence case refers to the capitalization used in normal prose, where the first letter of a sentence, proper nouns, and some other terms are capitalized, while other words remain lowercase.

Title case can be used in titles and can involve the first letter all words being capitalized, except non-initial articles like ‘a’, ‘the’, ‘and’, etc. An example of title case is “Big Joy, Little Prices.” All caps can be used for extreme emphasis and can involve all letters in every word being capitalized. For example, “BIG JOY, LITTLE PRICES.” By contrast, sentence case can be used for sub-titles and other content, such as marketing text, and can be capitalized similar to a standard English sentence. For example, “Big joy, little prices.”

Adhering to sentence-case specifications can help text be readable, professional-looking, and aligned with standard writing practices. However, maintaining consistent and correct sentence case across large volumes of marketing content can be challenging. Many e-commerce platforms and advertising systems deal with massive amounts of user-generated and automated content that may not adhere to proper capitalization rules. Product titles, ad headlines, and other marketing text often contain inconsistent or improper capitalization that can appear unprofessional or reduce readability. Additionally, certain words like brand names, acronyms, locations, nationalities, and other proper nouns may have specific capitalization that may not follow standard sentence case rules. Because display ads are often the first point of contact between a prospective customer and a product, presentation and accuracy can be beneficial for a successful marketing strategy. Many ad channels involve such ad copy, such as creative ads, brand shop webpages, etc., which can encompass multiple text and image components, such as eyebrow text, headline text, subhead text, call to action (CTA) text, etc. Sentence-case problems can be common, which can lead to grammatical errors and/or inefficient communication. For instance, a display ad may have all capital letters, lowercase letters, or a mix of both in inappropriate places, thereby disrupting the standard sentence casing rules. Such inconsistencies can potentially diminish customer experience and recued ad effectiveness.

Ensuring proper sentence case in marketing content has often relied heavily on manual review and editing by human moderators. However, this approach is time-consuming, costly, and prone to inconsistency and human error, especially when dealing with large volumes of content. Automated tools like basic spell-checkers or case converters often lack the contextual understanding to handle the nuances of marketing text, such as brand names or intentional stylistic choices. For example, automated approaches that use rule-based methods often struggle with handling exceptions and context-specific cases, and large language models can be slow, expensive, and incapable of detecting special cases like mixed casing, e.g., iPhone, iRobot, etc. Similarly, common tools like autocorrect, spell checkers, and case converters often perform poorly in the e-commerce domain. For example, a popular autocorrect tool can handle general dates, such as “Halloween” in an example ad copy, “Be a hero this halloween” and nationalities, such as “Mexican” in “Fun with mexican flavor”, while in ad copy that included the text “Give the gift of reebok” and “Samsung A13 lte $9.88,” the autocorrect tool failed to detect and correct the brand name “Reebok” and the acronym “LTE” in the ad copy. Additionally, when there are brand names that are not well known or exclusive to a retailer, etc., existing automated approaches generally fail.

In many embodiments, the techniques described herein can provide a sophisticated automated solution that can accurately detect and/or correct sentence-case issues in content (e.g., marketing and e-commerce content) while preserving beneficial exceptions. In some embodiments, such solutions can combine the strengths of multiple natural language processing (NLP) techniques to handle the complexities of real-world content, such as marketing text. Improved automated sentence-case correction can advantageously help to maintain consistent, professional-looking content at scale without relying solely on manual review. In many cases, the techniques described herein can provide accuracy improvements over manual techniques. In many embodiments, the techniques described herein can provide an ensemble of machine-learning models to detect and/or rectify sentence casing problems. In many embodiments, this ensemble of machine-learning models can combine unsupervised techniques, a custom name entity recognition (NER) model, and generative language models.

In many embodiments, these techniques can beneficially involve an automated deep-learning based sentence-case detection and/or correction model for creative ads moderation. In many embodiments, these techniques can build upon scalable, efficiently, and/or high-accuracy model ensembles. In many embodiments, these techniques can automatically generate sentence case correction suggestions for advertisers and/or moderators. In many embodiments, these techniques can accurately detect various entities, including proper nouns, exclusive brands, mixed-case entities, and acronyms. In many embodiments, these techniques can be robust to stop words and special characters. In many embodiments, these techniques can greatly improve accuracy and reduce processing time for sentence-case policy checking, which can account for a vast majority of total text policy violations.

The challenge of detecting acronyms, locations, nationalities, other proper nouns can be achieved using NER techniques. An NER model can be used to locate and classify named entities included in unstructured text into pre-defined groups. For example, groups (or facet types) can be general, such as brand, or category specific, such as bicycle wheel size, bicycle type, etc., for the item category of bicycles. Examples of named entities can be Mongoose (for the group of brand), mountain bike (for the group of bicycle type), 24-inch wheel (for the group of bicycle wheel size), etc. NER can be solved using naïve approaches, such as text matching, but that approach can be computationally intensive. Deep neural networks and language models can be leveraged to solve NER problems. For example, NER can be formulated as a sequential tagging (NER-ST) problem, in which the input is the list of tokens, and the output is a list of labels corresponding to each token. A transformer-based model (e.g. BERT (Bidirectional Encoder Representations from Transformers)) can be used for sequential tagging. The NER-ST model can input tokens and output labels. For example, for input tokens [mongoose, mountain, bike], the output can be [B-brand, B-bike_type, and I-bike_type]. However, NER-ST is not scalable to a large number of entity groups, as it involves creating a large scale of unique labels. Additionally, NER-ST is not generalizable to unseen entity groups.

In many embodiments, a question-answer NER (QA-NER) model can be generated and/or used, which can detect brand and eCommerce related entities. In many embodiments, the QA-NER model can be a novel question-answering (QA) architecture specialized for e-commerce. In many embodiments, the QA-NER model can accurately extract category-specific named entities from different types of text inputs, e.g., text copies of creative ads headline and subhead, search queries, ads keywords, item titles, product descriptions, etc. In many embodiments, the QA-NER model can discover more entity groups with high accuracy and efficiency, compared to existing search engines. In many embodiments, the QA-NER model can understand unseen entity groups and values, such as nationalities and holidays. In many embodiments, the QA-NER model can take as input a context and question, and can output an answer. For example, for context “mongoose mountain bike,” (i) if the question is “brand,” the answer can be “mongoose,” (ii) if the question is “bike type,” the answer can be “mountain bike,” and (iii) if the question is “color,” the answer can be “” (blank). In many embodiments, the QA-NER can be a scalable, generalizable, and/or maintainable model, which can extract a large variety of general and/or category-specific named-entities and/or brands with accuracy and/or efficiency.

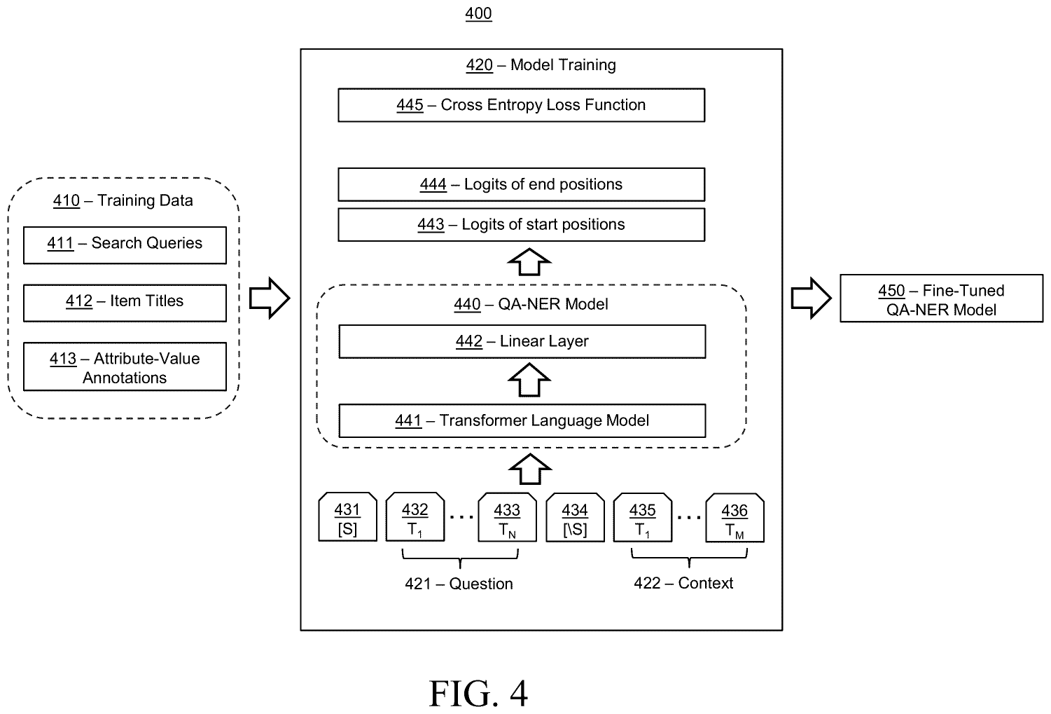

Turning ahead in the drawings, FIG. 4 illustrates flow chart for a training pipeline 400 for training a QA-NER model 440 using training data 410 to generate a fine-tuned QA-NER model 450. Training pipeline 400 is merely an example and is not limited to the embodiments presented herein. Training pipeline 400 can be employed in many different embodiments or examples not specifically depicted or described herein. In some embodiments, the procedures, the processes, and/or the activities of training pipeline 400 can be performed in the order presented. In other embodiments, the procedures, the processes, and/or the activities of training pipeline 400 can be performed in any suitable order. In still other embodiments, one or more of the procedures, the processes, and/or the activities of training pipeline 400 can be combined or skipped. In many embodiments, training pipeline 400 can be implemented using ML models system 313 (FIG. 3).

As shown in FIG. 4, training pipeline 400 can include using training data 410, which can include search queries 411, item titles 412, and attribute-value annotations 413. For example, search queries 411 can be search queries that have been input historically in a search engine, such as an eCommerce search engine or another suitable search engine. Item titles 412 can be the titles of items (e.g., product titles) in one or more eCommerce catalogs. Attribute-value annotations can be attribute-value pairs from one or more eCommerce datasets, such as from in-house and/or publicly available datasets. In many embodiments, training data 410 can be normalized before being used in model training 420.

Model training 420 can include creating training inputs and outputs for QA-NER model 440 based on training data 410. For example, the training input can include a question 421 and a context 422, which can be concatenated and represented by tokens (e.g., 431-436). In this example, token 431 can be a start delimiter token, tokens 432-433 can be N tokens, from 1-N, one for each word in question 421, token 434 can be a delimiter token, and tokens 435-436 can be M tokens, from 1-M, one for each word in context 422. Question 421 can be a facet type (e.g., attribute), such as brand, bike type, bike wheel size, etc., which can be obtained from attributes in attribute-value annotations 413. Context 422 can use input text, such as one of search queries 411, or one of item titles 412. The facet values in attribute-value annotations 413 can be used for training output. In many embodiments, for a given training input, QA-NER model 440 can output a logit of the start position 443 and a logit of the end position 444, such as the start and end position of the answer in the input text. For example, if context 422 is input text of “mongoose mountain bike,” and question 421 is attribute of “brand,” the output can be the start position and end position for “mongoose” within the input text.

In many embodiments, QA-NER model 440 can include a transformer language model 441 and a linear layer 442. Transformer language model 441 can be BERT, RoBERTa, TinyRoberta, or another suitable transformer language model. Tiny Roberta is a distilled version of the base RoBERTa, and it has been shown to achieve high accuracy while containing 6 layers and running at twice the speed of its base model to support online inferences. The TinyRoberta model can be pre-trained, such as on the SQuAD 2.0 dataset, which is a reading comprehension dataset consisting of context, 100,000 question and answer training data, as well as over 50,000 unanswerable questions. The pre-trained model has capability of understanding common questions and identify the answer of text segment or span from the corresponding context. In many embodiments, model training can involve tuning the pretrained model. In many embodiments, transformer language model 441 can output a feature embedding, such as a vector having dimensions of 512, 768, or another suitable dimension.

Subsequently, linear layer 442 can receive the feature embedding output from transformer language model 441 as input, and can extract and represent high-level features. In many embodiments, linear layer 442 can apply a linear transformation, through matrix multiplication and addition of linear layer weights with the feature embedding, to reduce the large-dimension vector (e.g., 768-dimensional input) to a 2-dimensional output (corresponding to the start and end positions (443, 444)). In many embodiments, the linear layers weights can be denoted by W, the feature embedding can be denoted by X, and the linear layer can produce y=WX, where y is of dimension 2, X is of dimension 768, and W is 2*768. The linear layer can act as classifications head and produce logits, which can be real numbers. The real-number logits can be converted through a softmax function, into a probability distribution of the possible outcomes, representing the probability of each input token being the start position and end position of the answer to the input question. In many embodiments, QA-NER model 440 can be tuned with the training datasets using a cross entropy loss function 445 in order to generate fine-tuned QA-NER model 450. For example, QA-NER model can be tuned with the training datasets for 5 epochs, or another suitable number of epochs, to update the parameters of transformer language model 441 and linear layer 442.

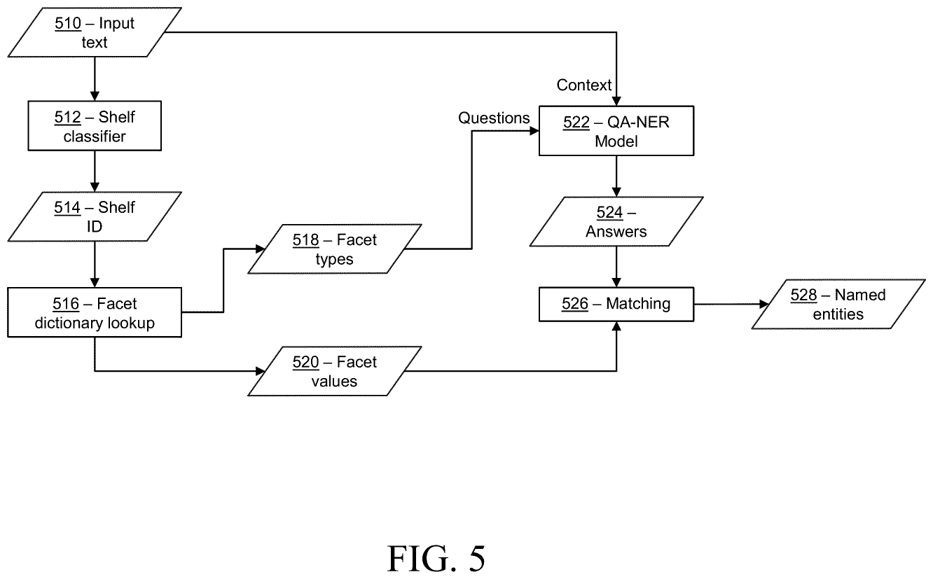

Turning ahead in the drawings, FIG. 5 illustrates flow chart for an inference pipeline 500 for using a QA-NER model 522, which can be similar or identical to fine-tuned QA-NER model 450 (FIG. 4). Inference pipeline 500 is merely an example and is not limited to the embodiments presented herein. Inference pipeline 500 can be employed in many different embodiments or examples not specifically depicted or described herein. In some embodiments, the procedures, the processes, and/or the activities of inference pipeline 500 can be performed in the order presented. In other embodiments, the procedures, the processes, and/or the activities of inference pipeline 500 can be performed in any suitable order. In still other embodiments, one or more of the procedures, the processes, and/or the activities of inference pipeline 500 can be combined or skipped. In many embodiments, inference pipeline 500 can be implemented using ML models system 313 (FIG. 3).

As shown in FIG. 5, inference pipeline 500 can start with obtaining input text 510, which can be one of search queries 411 (FIG. 4) and/or one of item titles 412 (FIG. 4). As an example, a search query used as input text 510 can be “black mongoose aluminum mountain bike.” Input text 510 can be used a context that is input into QA-NER model 522 (similar to context 422 (FIG. 4)). For a given input text (e.g., context 422), a list of questions can be constructed from facets (attributes), such as attributes in attribute-value annotations 413. These questions can be similar to question 421 (FIG. 4). In many embodiments, a wide universe of facets can be used to maximize the number of entities extracted and/or minimize the number of questions asked, to save computation resource and time. In a number of embodiments, the input text is not already associated with a category (e.g., shelf of the eCommerce catalog), such as for search queries. To fetch relevant facet types for an input text (e.g., search query), a shelf ID (identifier) 514 can be assigned by utilizing a shelf classifier 512, such as BERT or another suitable classifier. For the search query example, the shelf ID can be 4193522, which can be the shelf ID for the shelf of adult bikes in the eCommerce catalog. Subsequently, a facet dictionary lookup 516 can be performed using shelf ID 514 as the lookup key to retrieve the corresponding facet types 518 and facet values 520. An example of a facet table for facet dictionary lookup 516 is shown in Table 1 below.

TABLE 1
Shelf ID: “4171_3438149_6621100_7734367”:
“Brand”: [“Razor”],
“Departments”: [“Razor Tricycles”],
“Fulfillment Speed”: [“Today”, “Tomorrow”, “2 days”, “Anytime”],
“Customer Rating”: [“4-5 Stars”, “3-3.9 Stars”, “2-2.9 Stars”, “1-1.9 Stars”],
“Color”: [“Blue”, “Pink”, “Red”, “Yellow”, “Black”],
“Product Category”: [“Tricycles”],
“Material”: [“Steel”],
“Fulfillment Method”: [“Pickup”, “Delivery”, “Shipping”, “W+Free shipping”, “In-store”],
“Gender”: [“Boys”, “Unisex”],
“Age”: [“12 Years & Up”, “5 to 7 Years”, “8 to 11 Years”],
“Lifestage”: [“Adult”, “Child”, “Teen”]}

For the search query example, facet types 518 can be “wheel size”, “brand”, “bicycle type”, “color”, “material”, “gender”, “lifestage”, etc. Facet types 518 can be used as questions in QA-NER model 522. Similarly as described above for model training 420 (FIG. 4), the question and context can be combined as inputs to QA-NER model 522. In the search query example, context-question combinations can be: {CONTEXT: black mongose aluminum mountain bike, QUESTION: wheel size}, {CONTEXT: black mongose aluminum mountain bike, QUESTION: brand}, {CONTEXT: black mongose aluminum mountain bike, QUESTION: bicycle type}, etc.

In many embodiments, QA-NER model 522 can output answers 524 based on the questions and context input into QA-NER model 522. In the search query example, for the “wheel size” question, the answer can be “” (blank). For the “brand” question, the answer can be “mongose.” For the “bicycle type” question, the answer can be “mountain bike.” Answers 524 can contain misspellings (in this case “mongose” instead of “mongoose”, as directly extracted from input 510). The subsequent (edit-distance based) matching 526 can find the correct value “mongoose”.

Facet values 520 can list the facet values associated with each facet type. In the search query example, the facet values can be as follows:
“bicycle type”: “bmx bikes”, “fat tire bikes”, “mountain bikes”, “training-wheel bikes”
“material”: “alloy”, “aluminum”, “metal”, “rubber”, “steel” etc.

In many embodiments, matching 526 can be performed on answers 524 using facet values 520, to determine named entities 528, which can be the attribute-value pairs for facet values in input text 510. To support many types of input text 510, such as ads and marketing applications, an edit-distance based matching can be performed in matching 526, which can map answer 524 extracted from input text 510 to facet values in the facet universe. In many embodiments, for matching 526, a linear-time algorithm can be used to support the robust mapping to values that are one edit distance away. In some embodiments, a polynomial-time algorithm can be used for matching 526 to support the robust mapping of edit distance greater than one. Using such mapping can further boost the performance of inference pipeline 500. In many embodiments, inference pipeline 500 can include fuzzy matching to be robust to misspellings (e.g., the above example misspelling of “mongose” instead of “Mongoose”). In many embodiments, embarrassing results can be eliminated from the facet values in facet dictionary lookup 516 to avoid such results in named entities 528. For the search query example, the named entities can be as follows:
“brand”: “mongoose”
“bicycle type”: “mountain bikes”
“color”: “black”
“material”: “aluminum”etc.

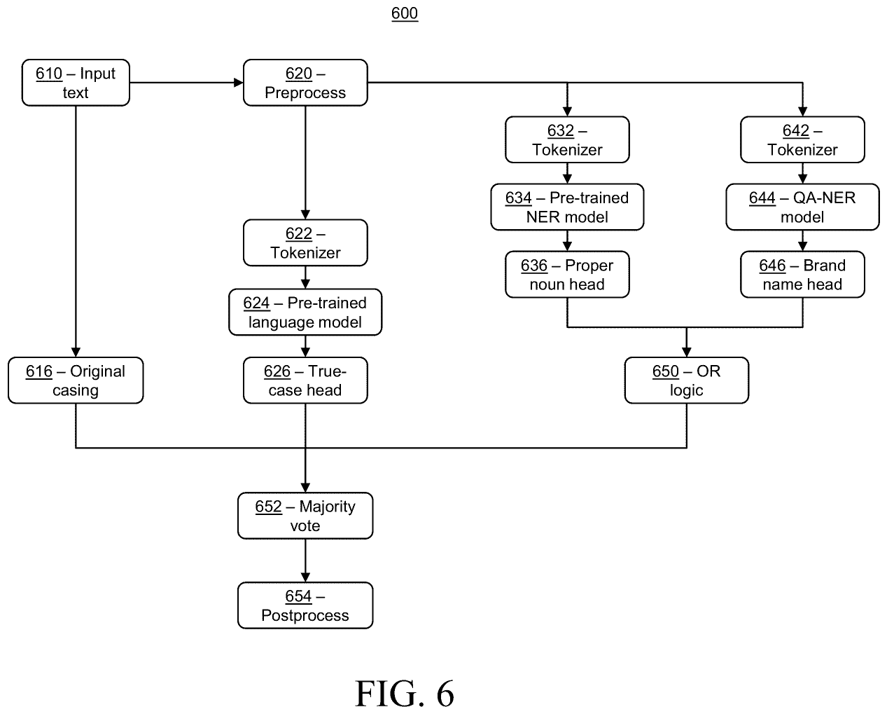

Turning ahead in the drawings, FIG. 6 illustrates flow chart for an ensemble pipeline 600 for using an ensemble of models to generate corrected sentence-case text. Ensemble pipeline 600 is merely an example and is not limited to the embodiments presented herein. Ensemble pipeline 600 can be employed in many different embodiments or examples not specifically depicted or described herein. In some embodiments, the procedures, the processes, and/or the activities of ensemble pipeline 600 can be performed in the order presented. In other embodiments, the procedures, the processes, and/or the activities of ensemble pipeline 600 can be performed in any suitable order. In still other embodiments, one or more of the procedures, the processes, and/or the activities of ensemble pipeline 600 can be combined or skipped. In many embodiments, ensemble pipeline 600 can be implemented using sentence-case system 310.

In many embodiments, ensemble pipeline 600 can be used for sentence-case detection and/or correction, which can beneficially include a technical innovation of identifying brand names to address the challenge of sentence-case detection in the eCommerce domain. In many embodiments, ensemble pipeline 600 can use ensemble techniques to leverage the strength of multiple base models and improve overall performance. Ensemble methods can improve the accuracy of results in models by combining multiple models instead of using a single one. To address the challenge of detection of various entitles in the eCommerce domain, multiple models can be combined, such as three models, each of which can specialize in different types of entities. In many embodiments, the original input text casing can be considered to construct the ensemble model for sentence case detection and correction.

As shown in FIG. 6, ensemble pipeline 600 can start with obtaining input text 610. Input text 610 can be similar to input text 510 (FIG. 5). In many embodiments, input text 610 can be content, such as product descriptions, marketing content, and or other types of content, which can be human-generated or auto-generated. In various embodiments, input text 610 can be input into a preprocess 620, which can involve special character removal, trimming, sentence splitting, and/or other suitable preprocessing activities. After preprocessing, the input text 610 can be tokenized, such as in three separate tokenizers 622, 632, 642, or in a single tokenizer that is used across the models of the ensemble. In many embodiments, the tokenization can be word tokenization, to divide the input text into word tokens, such as individual words, compound words, word phrases, etc. In many embodiments, the models of the ensemble can include a pre-trained language model 624, a pre-trained NER model 634, a QA-NER model 644, and/or other suitable models.

In many embodiments, pre-trained language model 624 can be configured to determine capitalization for mixed cases, acronyms, and/or general proper nouns. In some embodiments, pre-trained language model 624 can be the XLM-Roberta model, which can be pretrained on a large dataset of true cased text, such as 10 million examples, or another suitable model. As examples, for input text of “ATVs & trucks,” pre-trained language model 624 can identify that “ATVs” is an acronym. For input text of “Save $100 on iPhone,” pre-trained language model 624 can identify that “iPhone” is mixed-case. For input text of “Choose TV Stand Here,” pre-trained language model 624 can identify that “Choose” is the first letter of a sentence, and that “TV” is an acronym. In many embodiments, the output of pre-trained language model 624 can be a true-case head 626, which can be a vector indicating whether a character or word of the input text should be capitalized.

In many embodiments, pre-trained NER model 634 can be configured to determine capitalization for determine capitalization for general proper nouns, such as organizations, product names, nationality, dates, etc. In some embodiments, pre-trained NER model 634 can be the SpaCy NER model. As examples, for input text of “Asus I510 15″ laptop,” pre-trained NER model 634 can identify that “Asus” is an organization, that “I510” is a product name, and that “15” is a quantity. For input text of “Fun with Mexican flavor,” pre-trained NER model 634 can identify that “Mexican” is a nationality. For input text of “Gift for this Valentine's Day,” pre-trained NER model 634 can identify that “Valentine's Day” is a date. In many embodiments, the output of pre-trained NER model 634 can be a proper noun head 636, which can be a vector indicating whether a character or word in the input text should be capitalized.

In many embodiments, QA-NER model 644 can be similar or identical to fine-tuned QA-NER model 450 (FIG. 4), inference pipeline 500 (FIG. 5), and/or QA-NER model 522 (FIG. 5). In many embodiments, QA-NER model 644 can be configured to extract the brand name entities from the input text, including headline, subhead, eyebrow, etc. As examples, for input text of “Feed now with Scotts® Brand,” QA-NER model 644 can identify that “Scotts®” is a brand. For input text of “New Fisher-Price toys for kids,” QA-NER model 644 can identify that “Fisher-Price” is a brand. For input text of “Uno by Mattel,” QA-NER model 644 can identify that “Uno” is a brand, and that “Mattel” is a brand. In many embodiments, the output of QA-NER model 644 can be a brand name head 646, which can be a vector indicating whether a character or word in the input text should be capitalized.

In a number of embodiments, ensemble logic can be performed on the outputs of the models (e.g., 624, 634, and/or 644) and/or an original casing 616 of input text 610. For example, as shown in FIG. 6, the ensemble logic can include performing OR logic 650 (logical disjunction) on proper noun head 636 and brand name head 646, and performing majority voting on original casing 616, true-case head 626, and the output of OR logic 650. In other embodiments, other suitable ensemble logic can be performed.

As an example, input text 610 can be “Dream big with barbie this Valentine's day.” In many embodiments, binary vectors can be used for original casing 616, true-case head 626, proper noun head 636, and brand name head 646, in which a value of 1 indicates the word should be capitalized and 0 otherwise. Original casing 616 for this example shows that the first and sixth words of the seven words are capitalized, so the vector (representing the capitalization of each word) for original casing 616 can be [1,0,0,0,0,1,0]. Pre-trained language model 624 can indicate that “Dream” should be capitalized as the first word of the sentence, that “barbie” should be capitalized as a brand, and that “Valentine's Day” should be capitalized as a date, so the vector for true-case head 626 can be [1,0,0,1,0,1,1]. Pre-trained NER model 634 can indicate that “Valentine's Day” should be capitalized as a date, so the vector for proper noun head 636 can be [0,0,0,0,0,1,1]. QA-NER model 644 can indicate that “Barbie” should be capitalized as a brand, so the vector for brand name head 646 can be [0,0,0,1,0,0,0]. Performing OR logic 650 on each element of the vectors for proper noun head 636 and brand name head 646 can output [0,0,0,1,0,1,1]. Performing majority voting 652 on each element of the vectors for original casing 616, true-case head 626, and the output of OR logic 650 can output [1,0,0,1,0,1,1].

In many embodiments, the vector output by majority voting 652 can be used in a postprocess 654 to identify words for which the capitalization should be changed. For example, postprocess 654 can compare the output of majority voting 652 to original casing 616 to determine which words should be changed. In many embodiments, postprocess 654 can use the output of majority voting 652 to generate corrected text based on the input text. For example, in this case, based on the output [1,0,0,1,0,1,1], the first, fourth, sixth, and seventh words of input text 610 can be capitalized to be “Dream big with Barbie this Valentine's Day”. If there one or more words should be changed, the detection of such violations can be output as a violation comment and/or correction suggestion.

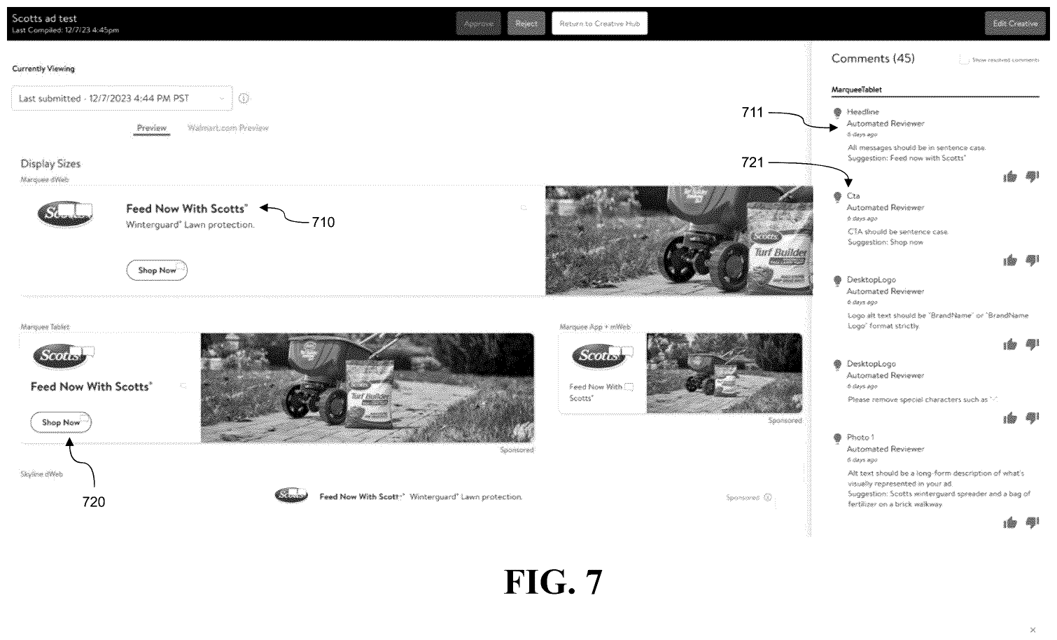

In some embodiments, corrected sentence-case text can be output on a draft advertisement user interface. For example, FIG. 7 illustrates an example of a user interface 700, showing a piece of content for ad copy, with identification of corrections to be made. For example, text 710 of “Feed Now With Scotts®” has a correction comment 711 suggesting that text 710 be revised as “Feed now with Scotts®”. Text 720 of “Show Now” on a call-to-action (CTA) button 720 has a correction comment 721 suggesting that text 720 be revised as “Show now”.

Returning to FIG. 6, in some embodiments, postprocess 654 can include transforming word-level vectors to character-level vectors to obtain the prediction of casing for each character. For example, some words have a mixed-case word, such as iPhone, in which the capitalization is not on the first letter, but a different letter, in this case, the second letter.

In many embodiments, ensemble pipeline 600 can provide several advantages. For example, ensemble pipeline 600 can advantageously provide an automated deep-learning based sentence-case detection and correction model for content moderation. In many embodiments, ensemble pipeline 600 can advantageously handle different types of tasks flexibly by using different types of base models and aggregation methods. In many embodiments, ensemble pipeline 600 can advantageously improve accuracy and performance better than single model, especially for complex and noisy sentence case problems. In many embodiments, ensemble pipeline 600 can advantageously capturing retailer-exclusive brand names by training QA-NER model 644 based on such retailer-exclusive brand names. In many embodiments, ensemble pipeline 600 can advantageously build upon scalable, efficient, and high-accuracy model ensembles to accurately detect various entities, including proper nouns, retailer-exclusive brands, mixed-case entities, acronyms, etc. In many embodiments, ensemble pipeline 600 can advantageously be robust to stop words and special characters, and/or can automatically generate sentence-case correction suggestion for users.

Performance testing of the QA-NER model (e.g., 644) indicated a 5% improvement in exact matches over an NER-ST model, decreasing average runtime to be approximately one-third of the runtime of the NER-ST model, and increasing the number of named entities found by approximately 13%. Additionally, the QA-NER model worked on three times as many category-specific facet types.

Performance testing of the ensemble technique (e.g., ensemble pipeline 600) indicated that it was 13.84% more accurate than human moderator and 99.5% faster than human moderation. Additionally, the ensemble technique improved accuracy by 50% over traditional text mining techniques.

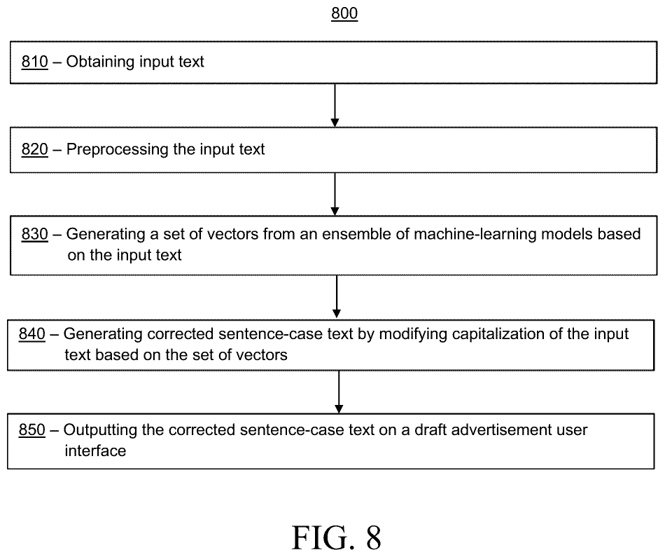

Jumping ahead in the drawings, FIG. 8 illustrates a flow chart for a method 800 of generating corrected sentence-case text, according to another embodiment. Method 800 is merely an example, and the method is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

In many embodiments, system 300 (FIG. 3), sentence-case system 310 (FIG. 3), and/or web server 320 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1). In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

Referring to FIG. 8, method 800 can include an activity 810 of obtaining input text. The input text can be similar or identical to context 422 (FIG. 2), input text 510 (FIG. 5), and/or input text 610 (FIG. 6). In many embodiments, activity 810 can be performed by communication system 311 (FIG. 3) and/or web server 320 (FIG. 3).

In many embodiments, method 800 also can include an activity 820 of preprocessing the input text to remove special characters and extra spaces. In many embodiments, activity 820 can be similar or identical to preprocess 620 (FIG. 6). In many embodiments, activity 810 can be performed by preprocessing system 312 (FIG. 3) and/or web server 320 (FIG. 3).

In many embodiments, method 800 additionally can include an activity 830 of generating a set of vectors from an ensemble of machine-learning models based on the input text. In many embodiments, the ensemble of machine-learning models can include (i) a pre-trained language model configured to determine capitalization for mixed cases and acronyms, which can be similar or identical to pre-trained language model 624 (FIG. 6); (ii) a pre-trained NER model configured to determine capitalization for general proper nouns, which can be similar or identical to pre-trained NER model 634 (FIG. 6); and/or (iii) a question-answer NER (QA-NER) model configured to determine capitalization for brand names, which can be similar or identical to fine-tuned QA-NER model 450 (FIG. 4), QA-NER model 522 (FIG. 5), and/or QA-NER model 644 (FIG. 6). In many embodiments, the set of vectors can be similar or identical to original casing 616 (FIG. 6), true-case head 626 (FIG. 6), proper noun head 636 (FIG. 6), and/or brand name head 646 (FIG. 6).

In many embodiments, the QA-NER model can include a transformer language model and a linear layer. The transformer language model can be similar or identical to transformer language model 441 (FIG. 4). The linear layer can be similar or identical to linear layer 442 (FIG. 4). The linear layer can be configured to reduce a vector output from the transformer language model to a two-dimensional vector comprising a start position and an end position of a brand in the input text. The start position can be similar or identical to logits of start positions 443 (FIG. 4), and the end position can be similar or identical to logits of end positions 444 (FIG. 4). In many embodiments, the transformer language model and/or the linear layer can be trained in a suitable number (e.g., five (5), etc.) of epochs to optimize cross entropy loss. In many embodiments, the start position and the end position that are output from the linear layer can be converted to probabilities through a softmax function in training the QA-NER model. In many embodiments, the QA-NER model can take as input a concatenation of the input text and a facet type and can output an answer from the input text for the facet type. In a number of embodiments, activity 830 can be performed by ML models system 313.

In many embodiments, method 800 further can include an activity 840 of generating corrected sentence-case text by modifying capitalization of the input text based on the set of vectors. In many embodiments, activity 840 of generating the corrected sentence-case text further can include performing a majority voting based on the set of vectors. The majority voting can be similar or identical to majority vote 652 (FIG. 6). In many embodiments, each respective vector of the set of vectors can indicate whether to capitalize each respective character of the input text. In many embodiments, the majority voting can be performed on (i) an original casing vector (e.g., 616 (FIG. 6)), (ii) a true-case head vector (e.g., 626 (FIG. 6)) that is output from the pre-trained language model, and (iii) a logical disjunction (e.g., 650 (FIG. 6)) of a proper noun head vector (e.g., 636 (FIG. 6)) that is output from the pre-trained NER model and a brand name head vector (e.g., 646 (FIG. 6)) that is output from the QA-NER model. In a number of embodiments, activity 840 can be performed by ensemble logic system 314 (FIG. 3) and/or postprocessing system 315 (FIG. 3).

In many embodiments, method 800 additionally can include an activity 850 of outputting the corrected sentence-case text on a draft advertisement user interface. For example, the draft advertisement user interface can be similar or identical to user interface 700 (FIG. 7), and/or the corrected sentence-case text can be similar or identical to the corrected text in correction comments 711 and/or 721 (FIG. 7). In a number of embodiments, activity 850 can be performed by communication system 311 (FIG. 3) and/or web server 320 (FIG. 3).

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although generating corrected sentence-case text has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 4-6 and 8 may include different procedures, processes, and/or activities and be performed by many different modules, in many different orders, and/or one or more of the procedures, processes, or activities of FIGS. 4-6 and 8 may include one or more of the procedures, processes, or activities of another different one of FIGS. 4-6 and 8. As another example, the systems within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions that, when executed on the processor, cause the processor to perform operations comprising:
obtaining input text;
generating a set of vectors from an ensemble of machine-learning models based on the input text, wherein the ensemble of machine-learning models comprise a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names, wherein the QA-NER model comprises a transformer language model and a linear layer, wherein the linear layer is configured to reduce a vector output from the transformer language model to a two-dimensional vector comprising a start position and an end position of a brand in the input text; and
generating corrected sentence-case text by modifying capitalization of the input text based on the set of vectors.

2. The system of claim 1, wherein the operations further comprise:
causing the corrected sentence-case text to be outputted on a draft advertisement user interface.

3. The system of claim 1, wherein generating the corrected sentence-case text further comprises:
performing a majority voting based on the set of vectors, wherein each respective vector of the set of vectors indicates whether to capitalize each respective character of the input text.

4. The system of claim 3, wherein the majority voting is performed on (i) an original casing vector, (ii) a true-case head vector that is output from the pre-trained language model, and (iii) a logical disjunction of a proper noun head vector that is output from the pre-trained NER model and a brand name head vector that is output from the QA-NER model.

5. The system of claim 1, wherein the transformer language model and the linear layer are trained in epochs to optimize cross entropy loss.

6. The system of claim 1, wherein the start position and the end position that are output from the linear layer are converted to probabilities through a softmax function in training the QA-NER model.

7. The system of claim 1, wherein the QA-NER model takes as input a concatenation of the input text and a facet type and outputs an answer from the input text for the facet type.

8. The system of claim 1, wherein the operations further comprise, before generating the set of vectors:
preprocessing the input text to remove special characters and extra spaces.

9. A computer-implemented method comprising:
obtaining input text;
preprocessing the input text to remove special characters and extra spaces;
generating a set of vectors from an ensemble of machine-learning models based on the input text, wherein the ensemble of machine-learning models comprise a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names, wherein the QA-NER model comprises a transformer language model and a linear layer, wherein the linear layer is configured to reduce a vector output from the transformer language model to a two-dimensional vector comprising a start position and an end position of a brand in the input text; and
generating corrected sentence-case text by modifying capitalization of the input text based on the set of vectors.

10. The computer-implemented method of claim 9 further comprising:
causing the corrected sentence-case text to be outputted on a draft advertisement user interface.

11. The computer-implemented method of claim 9, wherein generating the corrected sentence-case text further comprises:
performing a majority voting based on the set of vectors, wherein each respective vector of the set of vectors indicates whether to capitalize each respective character of the input text.

12. The computer-implemented method of claim 11, wherein the majority voting is performed on (i) an original casing vector, (ii) a true-case head vector that is output from the pre-trained language model, and (iii) a logical disjunction of a proper noun head vector that is output from the pre-trained NER model and a brand name head vector that is output from the QA-NER model.

13. The computer-implemented method of claim 9, wherein the transformer language model and the linear layer are trained in epochs to optimize cross entropy loss.

14. The computer-implemented method of claim 9, wherein the start position and the end position that are output from the linear layer are converted to probabilities through a softmax function in training the QA-NER model.

15. The computer-implemented method of claim 9, wherein the QA-NER model takes as input a concatenation of the input text and a facet type and outputs an answer from the input text for the facet type.

16. A non-transitory computer-readable medium storing computing instructions that, when executed on a processor, cause the processor to perform operations comprising:
obtaining input text;
generating a set of vectors from an ensemble of machine-learning models based on the input text, wherein the ensemble of machine-learning models comprise a pre-trained language model configured to determine capitalization for mixed cases and acronyms, a pre-trained named entity recognition (NER) model configured to determine capitalization for general proper nouns, and a question-answer NER (QA-NER) model configured to determine capitalization for brand names, wherein the QA-NER model comprises a transformer language model and a linear layer, wherein the linear layer is configured to reduce a vector output from the transformer language model to a two-dimensional vector comprising a start position and an end position of a brand in the input text;
generating corrected sentence-case text by modifying capitalization of the input text based on the set of vectors; and
causing the corrected sentence-case text to be outputted on a draft advertisement user interface.

17. The non-transitory computer-readable medium of claim 16, wherein generating the corrected sentence-case text further comprises:
performing a majority voting based on the set of vectors, wherein each respective vector of the set of vectors indicates whether to capitalize each respective character of the input text.

18. The non-transitory computer-readable medium of claim 17, wherein the majority voting is performed on (i) an original casing vector, (ii) a true-case head vector that is output from the pre-trained language model, and (iii) a logical disjunction of a proper noun head vector that is output from the pre-trained NER model and a brand name head vector that is output from the QA-NER model.

19. The non-transitory computer-readable medium of claim 16, wherein:
the transformer language model and the linear layer are trained in epochs to optimize cross entropy loss; and
the start position and the end position that are output from the linear layer are converted to probabilities through a softmax function in training the QA-NER model.

20. The non-transitory computer-readable medium of claim 16, wherein:
the QA-NER model takes as input a concatenation of the input text and a facet type and outputs an answer from the input text for the facet type; and
the operations further comprise, before generating the set of vectors:
preprocessing the input text to remove special characters and extra spaces.
